(19) United States
(12) Patent Application Publication
(10) Pub. No.: US 2007/0107793 A1
(43) Pub. Date: May 17, 2007

(54) Liquid transfer pipe and liquid transfer system

(75) Inventor: Yukihiro Uehara, Shiga (JP)

Correspondence Address: GLOBAL IP COUNSELORS, LLP, 1233 20TH STREET, NW, SUITE 700, WASHINGTON, DC, 20036-2680, US

(73) Assignee: TORAY ENGINEERING CO., LTD., CHUO-KU (JP)

(21) Appl. No.: 10/581,742

(22) PCT Filed: Dec. 24, 2004
(86) PCT No.: PCT/JP04/19316

§ 371 Date: Jun. 6, 2006

(30) Foreign Application Priority Data
Dec. 26, 2003 (JP) 2003-432505

(51) Int. Cl. F16L 11/00

(52) U.S. Cl. 138/112

(57) ABSTRACT

Disclosed is a liquid transfer pipe comprising a thin first pipe (32a) of a small diameter in which a liquid can flow and a thick second pipe (32b) of a large diameter in which the first pipe (32a) is housed. By setting the outer diameter of the first pipe (32a) and the inner diameter of the second pipe (32b) so that the first pipe (32a) can be placed in the second pipe (32b) at least with a certain gap, the channel for flowing the liquid is not affected even when an external force is applied to the liquid transfer pipe.

### TECHNICAL FIELD

The present invention relates to a liquid transfer pipe and liquid transfer system. More particularly, the present invention relates to a liquid transfer pipe which can be handled with ease without scarce affection in liquid transfer performance, and a liquid transfer system for sending liquid through a liquid transfer pipe utilizing a negative pressure associated with sending of gas.

### BACKGROUND ART

From the past, a liquid transfer system for sending liquid through a liquid transfer pipe utilizing a negative pressure associated with sending of gas is proposed, and is practiced for various fields (refer to Japanese Patent Laid-Open Publication Nos. hei4-87654, 2003-135999, and 2003-136011).

The liquid transfer system disclosed in Japanese Patent Laid-Open Publication No. hei4-87654 comprises a spray nozzle, a blow nozzle for blowing air surrounding the spray nozzle, a liquid supplying passage for the spray nozzle, an open and close valve for intermittent liquid supplying, an air supplying passage for the blow nozzle, and an air supply control section for controlling the intermittence and pressure of air supplying.

When this liquid transfer system is employed, liquid is sent utilizing a negative pressure by blowing air from the blow nozzle under the condition where the open and close valve is opened.

The liquid transfer system disclosed in Japanese Patent Laid-Open Publication Nos. 2003-135999, and 2003-136011 comprises a nozzle having an air blowing section and a liquid sucking section, a high pressure air supplying section for supplying high pressure air to the nozzle, a liquid tank communicated to the liquid sucking section through a liquid supplying pipe in which an open and close valve is interposed, and a positive pressure supplying section for supplying positive pressure to a space within the liquid tank, the space being a negatively pressured space.

When this liquid transfer system is employed, liquid can be transferred together with air from the nozzle by carrying out supplying of high pressure air and supplying of positive pressure under a condition where the open and close valve is opened.

### DISCLOSURE OF THE INVENTION

Problems to be Solved by the Invention

When the liquid transfer system disclosed in Japanese Patent Laid-Open Publication No. hei4-87654 is employed, amount of transferred liquid can be controlled by controlling pressure, flowing speed and the like of air blown from the blow nozzle, but amount of transferred liquid cannot be controlled independently from pressure, flowing speed and the like of air, because only the spray nozzle is determined to have a small diameter and the open and close valve is provided in the liquid supplying passage having a relatively greater diameter. In other words, amount of transferred liquid cannot be controlled under a condition where pressure, flowing speed and the like of air are maintained to be constant.

When the liquid transfer system disclosed in Japanese Patent Laid-Open Publication Nos. 2003-135999, and 2003-136011 is employed, it seems possible that transferring speed of liquid is controlled by controlling high pressure air, and transferring amount of liquid is controlled by controlling positive pressure, respectively. In practice, transferring speed of liquid and transferring amount of liquid cannot be controlled independently from one another, because only the air blowing section and the liquid sucking section of the nozzle are determined to have a small diameter.

The liquid transfer pipe disclosed in Japanese Patent Laid-Open Publication Nos. hei4-87654, 2003-135999, and 2003-136011 is commonly used, generally, and has an extremely greater inner diameter compared with the nozzle section for transferring liquid using negative pressure. Therefore, the liquid transfer pipe is not adequate to transferring of liquid by very small amount (for example, not over several milliliters). When the liquid transfer pipe is employed in the liquid transfer system, disadvantages mentioned above arise. Further, when external force is applied to the liquid transfer pipe in its midway section, the liquid transfer pipe becomes flatten-out-like condition so that liquid cannot flow smoothly.

The present invention was made in view of the above problems.

It is a first object of the present invention to provide liquid transfer system which is scarcely affected by pressure which changes when flowing amount of outer gas has changed.

It is a second object of the present invention to provide a liquid transfer pipe suitable for use in such liquid transfer system.

Means for Solving the Problems

A liquid transfer pipe of a first aspect of the present invention comprises a first pipe for flowing liquid having thin-wall and small diameter, and a second pipe for housing the first pipe having thick-wall and large diameter, wherein the outer diameter of the first pipe and the inner diameter of the second pipe are determined so that the first pipe can be housed with predetermined gap within the second pipe.

This liquid transfer pipe sufficiently improves handling in its entirety because the first pipe is housed within the second pipe even when the first pipe has small diameter. Also, this liquid transfer pipe makes a ratio of the length of the liquid transfer pipe with respect to the inner diameter of the first pipe sufficiently greater with lengthening the entire length of the liquid transfer pipe not so much, thereby fluid resistance can be made greater sufficiently. Further, even when external force is applied to the liquid transfer pipe, the first pipe hardly becomes flatten-out condition so that smooth flowing of liquid is continuously maintained.

It is preferable that the outer diameter of the first pipe and the inner diameter of the second pipe are determined so that three or more fist pipes can be housed within the second pipe.

A liquid transfer system of a second aspect according to the present invention comprises the liquid transfer pipe of the first aspect, a liquid housing section communicated to one end of the liquid transfer pipe, a pressurization section for pressurizing the liquid housing section so that liquid is supplied to the liquid transfer pipe from the liquid housing section, a gas blowing section for blowing gas so that negative pressure is generated at the other end of the liquid transfer pipe, and a pressurized gas supplying section for supplying pressurized gas to the gas blowing section.

This liquid transfer system generates negative pressure at the other end of the liquid transfer pipe by supplying to and blowing from the gas blowing section with pressurized gas from the pressurized gas supplying section, and carries out liquid transferring at the flowing speed and the like in correspondence with the negative pressure. The liquid transfer amount is not changed by the negative pressure, and the liquid transfer amount can be controlled by the degree of pressurizing by the pressurization section, because the liquid transfer pipe is made its fluid resistance to be sufficiently greater resistance.

As a result, liquid transfer controlling by controlling of the pressurized gas and liquid transfer controlling by controlling the liquid housing section can be carried out independently from one another.

Effects of the Invention

The first aspect of the present invention has characteristic effects such that handling is sufficiently improved in its entirety, and a ratio of the length of the liquid transfer pipe with respect to the inner diameter of the first pipe is made sufficiently greater with lengthening the entire length of the liquid transfer pipe not so much, thereby fluid resistance can be made greater sufficiently.

The second aspect of the present invention has characteristic effects such that liquid transfer controlling by controlling of the pressurized gas and liquid transfer controlling by controlling the liquid housing section can be carried out independently from one another.

### BRIEF DESCRIPTION OF THE DRAWINGS

FIG. 1 is a schematic view of liquid transfer system of an embodiment according to the present invention;

FIG. 2 is a schematic longitudinal cross sectional view illustrating a drug solution supplying nozzle of an example, of the liquid transfer system illustrated in FIG. 1;

FIG. 3 is a schematic side view of the drug solution supplying nozzle illustrated in FIG. 2;

FIG. 4 is a schematic longitudinal cross sectional view illustrating a liquid transfer pipe of an example, of the liquid transfer system illustrated in FIG. 1;

FIG. 5 is a schematic perspective view illustrating a first step for assembling a liquid transfer pipe illustrated in FIG. 4;

FIG. 6 is a schematic perspective view illustrating a second step for assembling a liquid transfer pipe illustrated in FIG. 4;

FIG. 7 is a schematic perspective view illustrating a third step for assembling a liquid transfer pipe illustrated in FIG. 4;

FIG. 8 is a schematic perspective view illustrating a fourth step for assembling a liquid transfer pipe illustrated in FIG. 4;

FIG. 9 is a schematic longitudinal cross sectional view illustrating a fifth step for assembling a liquid transfer pipe illustrated in FIG. 4;

FIG. 10 is a schematic longitudinal cross sectional view illustrating a sixth step for assembling a liquid transfer pipe illustrated in FIG. 4;

FIG. 11 is a schematic longitudinal cross sectional view illustrating a seventh step for assembling a liquid transfer pipe illustrated in FIG. 4;

FIG. 12 is a schematic longitudinal cross sectional view illustrating a liquid transfer pipe of another example, of the liquid transfer system illustrated in FIG. 1;

FIG. 13 is a schematic longitudinal cross sectional view illustrating a liquid transfer pipe of a further example, of the liquid transfer system illustrated in FIG. 1;

FIG. 14 is a schematic longitudinal cross sectional view illustrating a liquid transfer pipe of a yet another example, of the liquid transfer system illustrated in FIG. 1;

FIG. 15 is a schematic longitudinal cross sectional view illustrating a liquid transfer pipe of a yet further example, of the liquid transfer system illustrated in FIG. 1;

FIG. 16 is a schematic longitudinal cross sectional view illustrating condition where external force is applied to a predetermined location of the liquid transfer pipe of the liquid transfer system illustrated in FIG. 1;

FIG. 17 is a diagram illustrating measurement results measured change in mist flowing amount (ml/min) with respect to drug solution tank pressure. (kPa) with the setting of compression gas (air) flowing amount (NL/min) to be 0, 5, 10, 15, and 17.5;

FIG. 18 is a schematic longitudinal cross sectional view illustrating a liquid transfer pipe of another arrangement, of the liquid transfer system illustrated in FIG. 1;

FIG. 19 is a schematic longitudinal cross sectional view illustrating a liquid transfer pipe of a further arrangement, of the liquid transfer system illustrated in FIG. 1;

FIG. 20 is a schematic longitudinal cross sectional view illustrating a liquid transfer pipe of a yet another arrangement, of the liquid transfer system illustrated in FIG. 1; and

FIG. 21 is a schematic longitudinal cross sectional view illustrating a liquid transfer pipe of a yet further arrangement, of the liquid transfer system illustrated in FIG. 1.

### DESCRIPTION OF REFERENCES

1 drug solution tank
2 drug solution supplying nozzle
3 drug solution supplying piping
4 compressed gas supplying piping
5 pressure adjustment section
32 liquid transfer pipe
32a first pipe
32b second pipe
45 flowing amount adjustment mechanism

### BEST MODE FOR CARRYING OUT THE INVENTION

Hereinafter, referring to the attached drawings, we explain a liquid transfer pipe and liquid transfer system of embodiments according to the present invention, in detail.

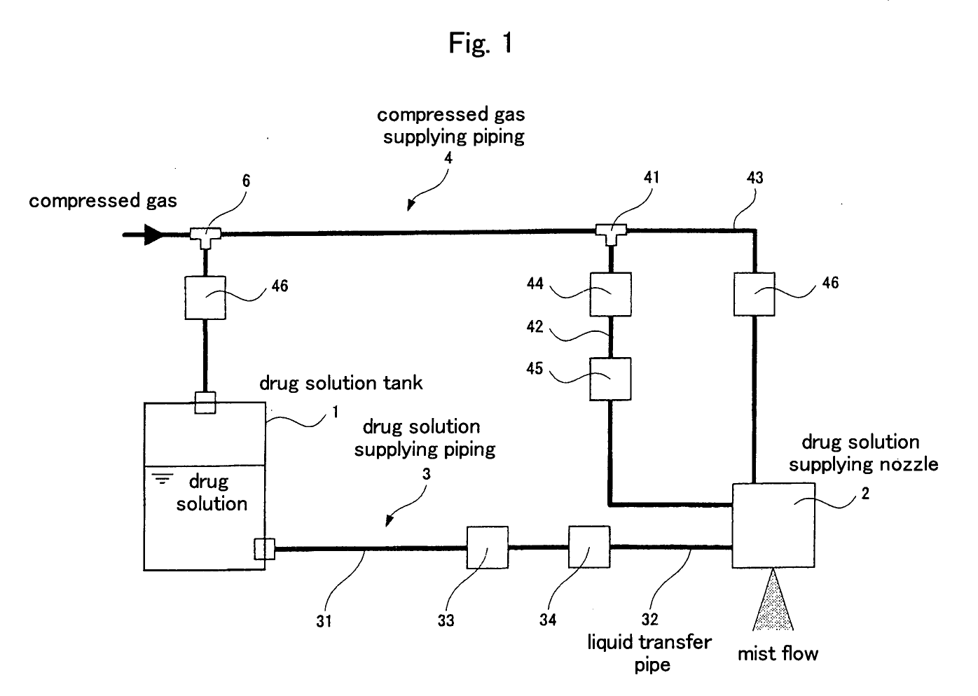

FIG. 1 is a block diagram illustrating liquid transfer system of an embodiment according to the present invention.

This liquid transfer system comprises a drug solution tank 1 which is a closed vessel, a drug solution supplying nozzle 2, drug solution supplying piping 3 for supplying drug solution to the drug solution supplying nozzle 2 from the drug solution tank 1, and compressed gas supplying piping 4 for supplying compressed gas to the drug solution supplying nozzle 2 from compressed gas supplying source not illustrated.

As the drug solution, pure water, water, ultrapure water, alcohol, thinner, cleaning substance and the like are exemplified. It is preferable that the drug solution has relatively low viscosity. Air is exemplified as the compressed gas, but inert gas such as nitrogen, noble gas and the like may be employed.

The drug solution tank 1 is communicated with the compressed gas supplying source through a pressure control section 5 and a guiding branch member 6, so that the interior of the drug solution tank 1 can be pressurized. A diaphragm regulator is exemplified as the pressure control section 5. The pressure control section 5 may be controlled by manual operation, or may be controlled by electric signals.

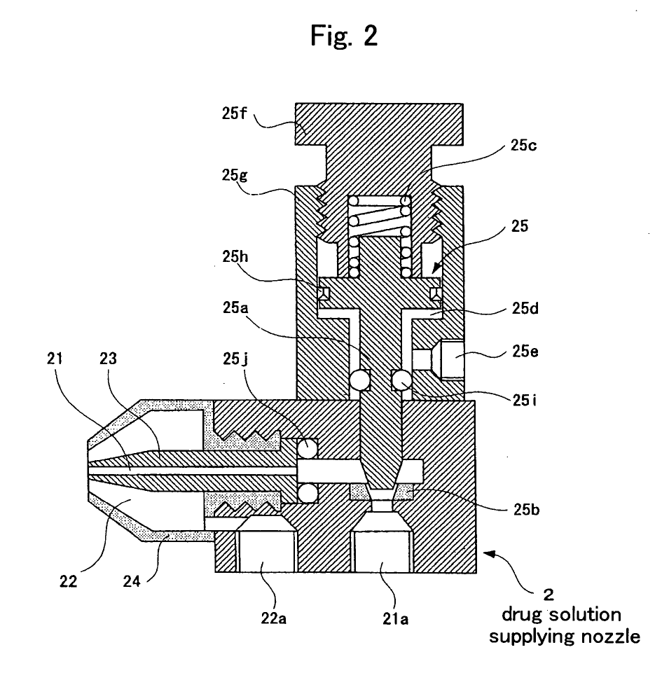

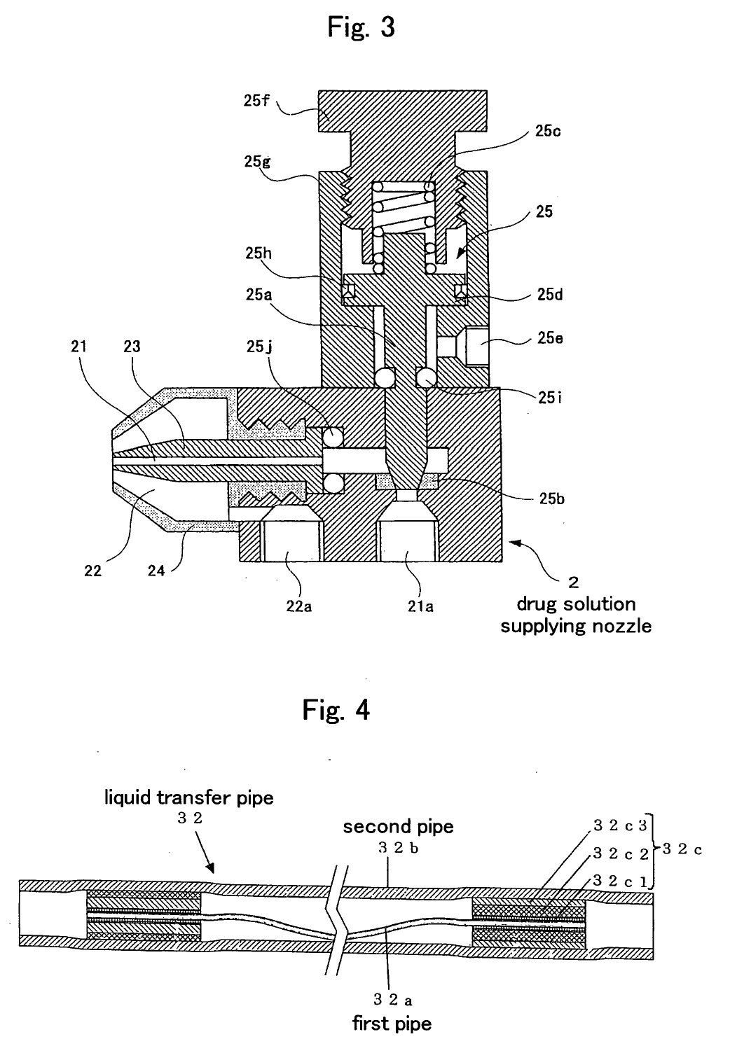

The drug solution supplying nozzle 2 comprises a drug solution passage 21, a compressed gas passage 22, a drug solution spraying nozzle 23, a compressed gas blowing nozzle 24, and an open and close valve mechanism (or flow control squeezer) 25 disposed at midway of the drug solution passage 21, the open and close valve mechanism 25 intermitting drug solution supplying, as is illustrated in FIGS. 2 and 3. The open and close valve mechanism 25 comprises a valve plug 25a, a seat ring 25b, a coil spring 25c for biasing the valve plug 25a in the closing direction, and a gas chamber 25d which is supplied compressed gas from the compressed gas supplying source for moving the valve plug 25a against the coil spring 25c. The drug solution spraying nozzle 23 and the compressed gas blowing nozzle 24 constitute a two fluid mixing nozzle of externally mixing system. The drug solution spraying nozzle 23 and the compressed gas blowing nozzle 24 may constitute a two fluid mixing nozzle of internally mixing system.

The drug solution supplying piping 3 comprises a main piping for drug solution 31 communicated with the drug solution tank 1, a liquid transfer pipe 32 connected between the main piping for drug solution 31 and the drug solution passage 21, a flowmeter 33 and an open and close mechanism 34 which intervene at midway of the main piping for drug solution 31.

An area flowmeter is exemplified as the flowmeter 33. The flowmeter 33 may be a mass flowmeter, a laser Doppler flowmeter, or the like. An electromagnetic three-way valve is exemplified as the open and close mechanism 34. The open and close mechanism 34 may be a manual changeover valve.

The compressed gas supplying piping 4 is communicated with the compressed gas supplying source through the guiding branch member 6, and comprises piping for mixed flow 42 and piping for opening and closing nozzle 43, the piping 42 and the piping 43 are branched by the guiding branch member 6. The piping for mixed flow 42 is communicated with the compressed gas passage 22. The piping for opening and closing nozzle 43 is communicated with the gas chamber 25d. A flowmeter 44 and a flow control mechanism 45 intervene in the piping for mixed flow 42. An open and close mechanism 46 intervenes in the piping for opening and closing nozzle 43.

An area flowmeter is exemplified as the flowmeter 44. The flowmeter 44 may be a mass flowmeter, a laser Doppler flowmeter, or the like. An electromagnetic three-way valve is exemplified as the open and close mechanism 46. The open and close mechanism 46 may be a manual changeover valve.

The liquid transfer pipe 32 comprises a first pipe 32a having small diameter for flowing drug solution, a second pipe 32a having large diameter for housing the first pipe 32a, and connecting members 32c disposed between both ends of the first pipe 32a and both near end sections of the second pipe 32a for connecting both pipes integrally. Specifically, it is preferable that the connecting member 32c is consisted with pipes 32c1, 32c2 and 32c3 forming a three layered pipe.

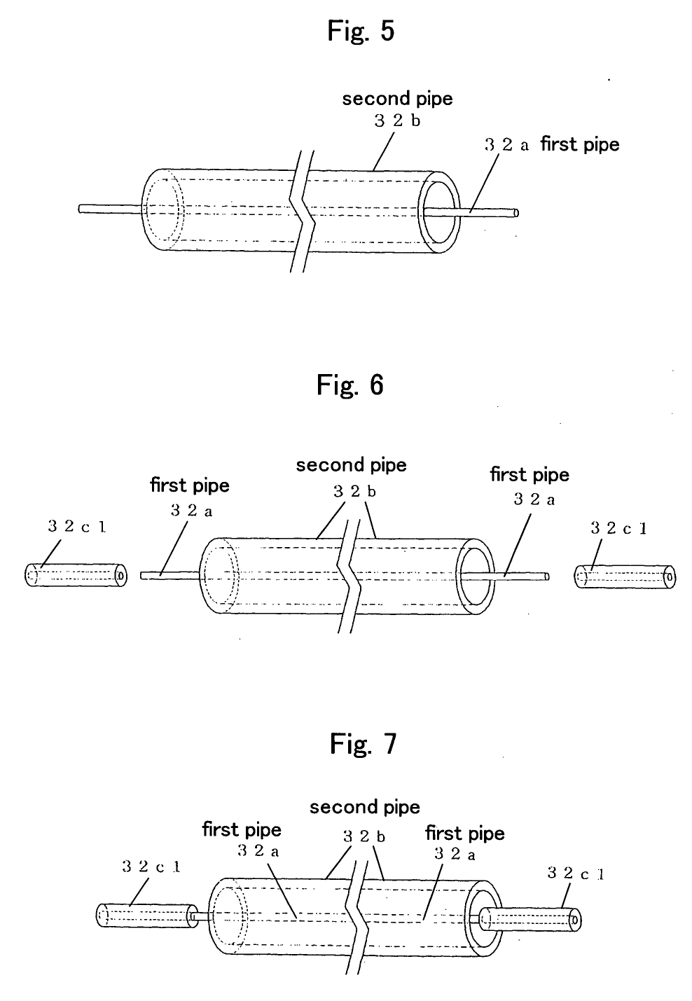

Referring to FIGS. 5-11, manufacturing of this liquid transfer pipe 32 is described.

At first, the first pipe 32a passes through the second pipe 32b, and is disposed (refer to FIG. 5).

Next, the pipe 32c1 is positioned in an extended condition of the first pipe 32a (refer to FIG. 6), then the first pipe 32a and the pipe 32c1 are fitted together without modification (refer to FIG. 7).

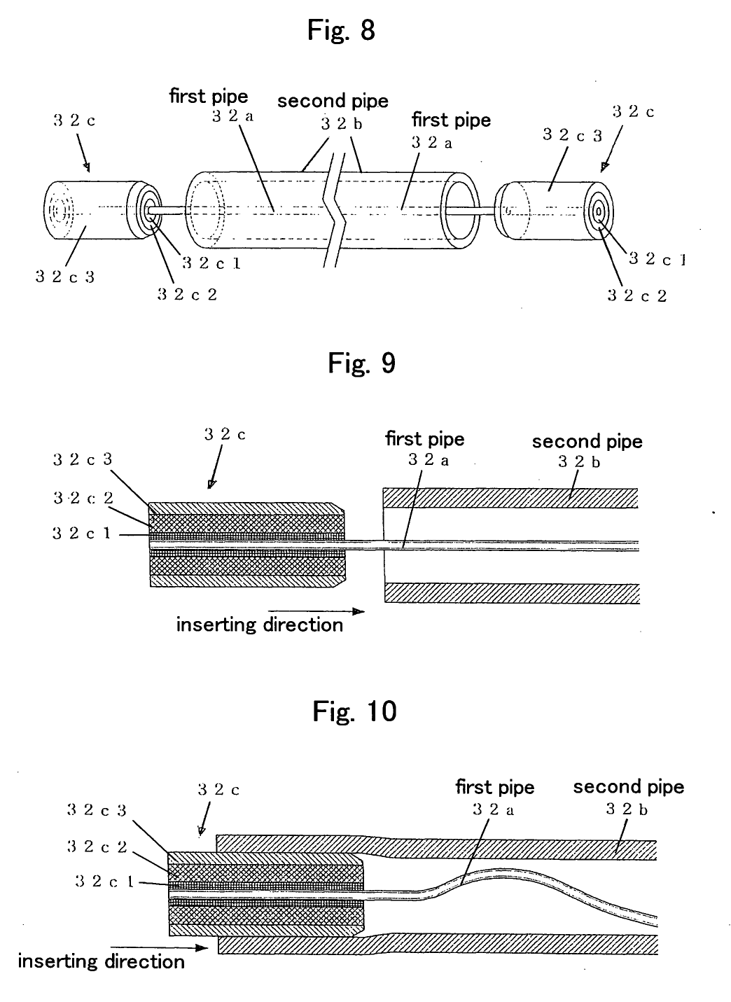

Similarly, The pipe 32c1 and the pipe 32c2 are fitted together, then the pipe 32c2 and the pipe 32c3 are fitted together (refer to FIG. 8). Chamfer is formed at an outer peripheral section of the pipe 32c3 in its closed side most closed to the second pipe 32b.

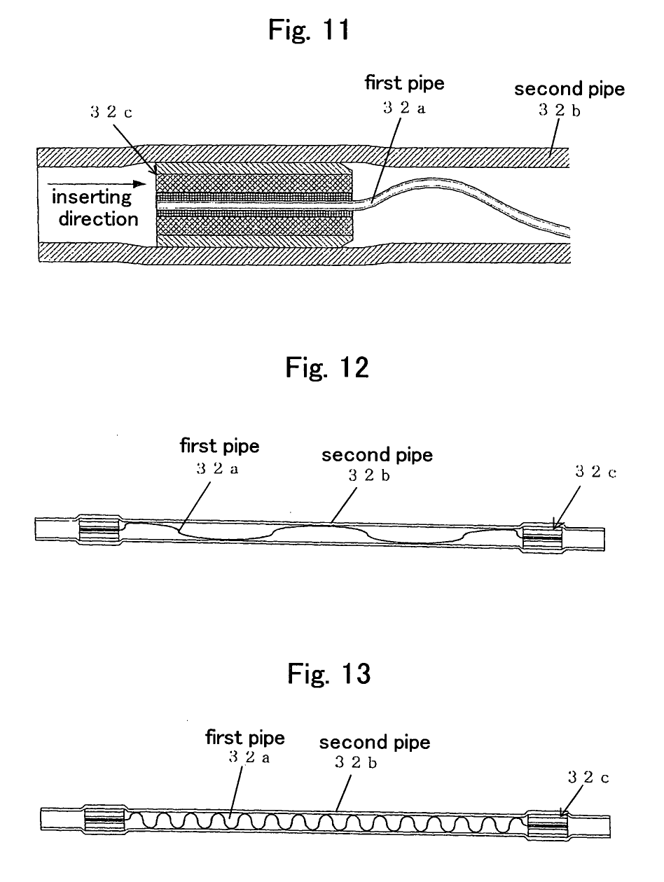

When the pipes 32c1, 32c2 and 32c3 forming a three layered pipe are sequentially fitted to the edge section of the first pipe 32a in this manner, the pipes 32c1, 32c2 and 32c3 forming a three layered pipe are moved in a direction illustrated by an arrow in FIG. 9, then the pipes 32c1, 32c2 and 32c3 forming a three layered pipe are inserted into the second pipe 32b, as is illustrated in FIG. 10. Inserting operation is carried out until the pipes 32c1, 32c2 and 32c3 forming a three layered pipe are inserted into the second pipe 32a by a predetermined distance from the edge of the second pipe 32b, finally, as is illustrated in FIG. 11, so that manufacturing of the liquid transfer pipe 32 is finished.

The first pipe 32a is set to have the length of 1000 mm, the inner diameter of 0.3 mm, and the outer diameter of 0.5 mm, and is made from fluoroplastic, for example. The first pipe 32a made from resin such as nylon, polyurethane, polyolefin, plastic etc., metallic material, non-metallic material or the like, may be used in conformity with characteristic of liquid.

The second pipe 32a is set to have the length of 300 mm, the inner diameter of 4 mm, and the outer diameter of 6 mm, and is made from fluoroplastic, for example. The second pipe 32b made from resin such as nylon, polyurethane, polyolefin, plastic etc., metallic material, non-metallic material or the like, the second pipe 32b made from the combination of the above material, the second pipe 32b made of tapered resin, the second pipe 32b made of metal press fitted to one another, or the like may be used in conformity with characteristic of liquid. By using material having high heat resistance for the second pipe 32b, the second pipe 32b can be used under a circumstance where the second pipe 32b temporarily contacts with high temperature substance. In this case, the second pipe 32b serves protection pipe under a circumstance where the first pipe 32a is melted when the second pipe 32b is not provided.

The pipe 32c1 is set to have the length of 10 mm, the inner diameter of 0.5 mm, and the outer diameter of 1.6 mm, and is made from fluoroplastic, for example. Because the inner diameter of this pipe 32c1 and the outer diameter of the first pipe 32a are the same to one another, both pipes 32a and 32c1 cannot be fitted on their own. When the inner diameter of the pipe 32c1 is temporarily increased by inserting a jig having tapered shape such as a needlepoint, the first pipe 32a can be inserted into the pipe 32c1. Then, the pipe 32c1 is constricted by itself when the jig is removed from the pipe 32c1. As a result, the pipe 32c1 and the first pipe 32a contact with one another so that fitted condition is maintained by the frictional force between the first pipe 32a and the pipe 32c1.

The pipe 32c2 is set to have the length of 10 mm, the inner diameter of 1.6 mm, and the outer diameter of 3.2 mm, and is made from fluoroplastic, for example. Because the inner diameter of this pipe 32c2 and the outer diameter of the pipe 32c1 are the same to one another, both pipes 32c1 and 32c2 cannot be fitted on their own. When the inner diameter of the pipe 32c2 is temporarily increased by inserting a jig having tapered shape such as a needlepoint, the pipe 32c1 can be inserted into the pipe 32c2. Then, the pipe 32c2 is constricted by itself when the jig is removed from the pipe 32c2. As a result, the pipe 32c2 and the pipe 32c1 contact with one another so that fitted condition is maintained by the frictional force between the pipe 32c1 and the pipe 32c2.

Fitting with the pipe 32c2 may be carried out after the fitting of the first pipe 32a with the pipe 32c1. Also, fitting with the first pipe 32a may carried out after the fitting of the pipe 32c2 with the pipe 32c1.

The pipe 32c3 is set to have the length of 10 mm, the inner diameter of 2.5 mm, and the outer diameter of 4 mm, and is made from polyurethane, for example. Because polyurethane has considerably great retractility, the pipe 32c2 can be inserted into the pipe 32c3 without use of a jig for expanding inner diameter regardless the outer diameter of the pipe 32c2 is greater than the inner diameter of the pipe 32c3. When the pipe 32c2 has inserted, force orienting towards the center acts for entire periphery due to contractive force of the pipe 32c3 itself. As a result, frictional forces between the pipes 32c1, 32c2 and 32c3 are increased, so that hardness in pulling out is improved.

Under this condition, the circumferential length of the pipe 32c3 becomes longer than the original circumferential length, and becomes longer than the inner circumferential length of the second pipe 32b, so that the pipe 32c3 cannot be inserted into the second pipe 32b on its own. But, in this embodiment, chamfer is formed on the outer circumferential section on a side of the pipe 32c3, the side contacting with the second pipe 32b when the pipe 32c3 is to be inserted into the second pipe 32b. Therefore, the outer circumferential length of the pipe 32c3 becomes shorter than the inner circumferential length of the second pipe 32b, so the pipe 32c3 can be inserted into the second pipe 32b. The outer circumferential section may be scraped partially instead forming chamfer for entire outer circumference. What matters is that the outer circumferential length of the pipe 32c3 is shorter than the inner circumferential length of the second pipe 32b.

After the insertion, the pipe 32c3 is inserted into sufficiently inner position of the second pipe 32b so that the outer diameter at the edge section of the second pipe 32b becomes equal to the original outer diameter. Specifically, it is sufficient that an edge section length L1 is maintained so that the second pipe 32b can be handled similarly to the original second pipe 32b.

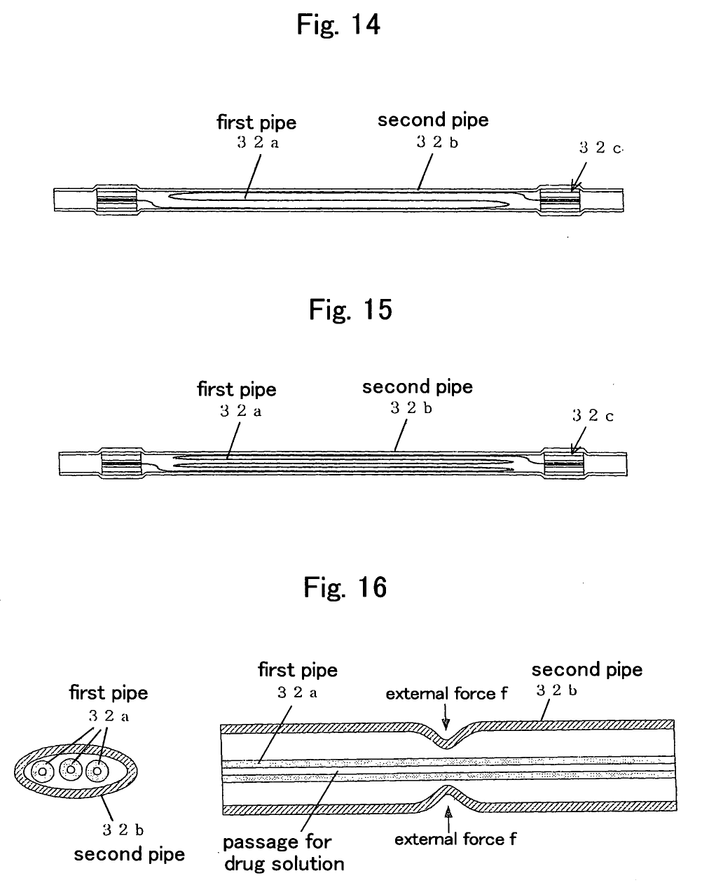

Relationship between the first pipe 32a and the second pipe 32b in the liquid transfer pipe 32 can be appropriately set, as is illustrated in FIGS. 12-15. Therefore, it is sufficient that optimal relationship is set in view of required fluid resistance etc.

Even when the liquid transfer pipe 32 of any configuration is employed, and even when external force is applied partial part of the liquid transfer pipe 32, the first pipe 32a is not changed its shape so that the inner cross sectional area is maintained to be a constant area, regardless of that the second pipe 32b is changed its shape depending on the external force, as is illustrated in FIG. 16 so that the second pipe 32b is decreased its inner cross sectional area locally.

Operation of the liquid transfer pipe having the above configuration is as follows.

The open and close valve mechanism 25 is operated by controlling the open and close mechanism 46 intervening in the piping for opening and closing nozzle 43 so that a status for interrupting drug solution supplying, or a status for allowing drug solution supplying is selected.

When the open and close valve mechanism 25 is operated to select the status for allowing drug solution supplying, pressure supplied to the drug solution tank 1 is controlled by the pressure control section 5 which is supplied compressed gas through the guiding branch member 6. As the result of this control, drug solution within the drug solution tank 1 is supplied to the drug solution passage 21 of the drug solution supplying nozzle 2 through the main piping for drug solution 31 having the flowmeter 33 and the open and close mechanism 34, and the liquid transfer pipe 32.

Flowing amount of compressed gas is controlled by the flow control mechanism 45, the compressed gas being supplied to the compressed gas passage 22 of the drug solution supplying nozzle 2 through the guiding branch members 6 and 41. As the result of this control, amount of compressed gas which blows from the compressed gas blowing nozzle 24 is determined, thereby negative pressure generated in the blowing section of the drug solution spraying nozzle 23 is determined.

Therefore, the amount of drug solution is supplied to the drug solution spraying nozzle 23, the amount corresponding to the controlled pressure, drug solution is drawn by negative pressure due to compressed gas blown from the compressed gas blowing nozzle 24, then mist flow is sent out, the mist flow being generated by mixing the drug solution and the compressed gas.

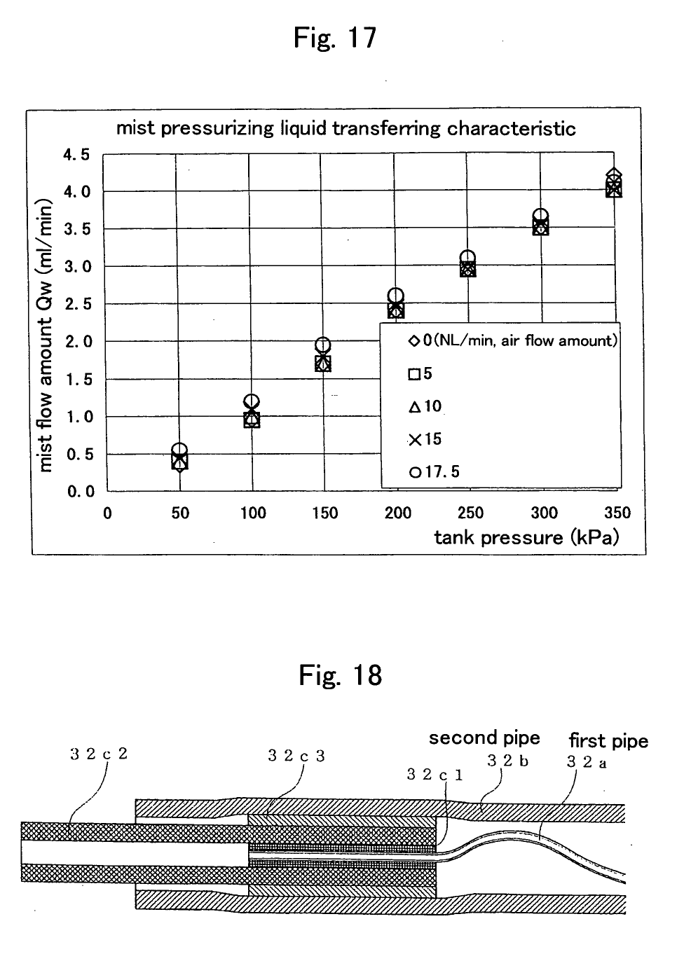

In this case, when change in mist flow amount (ml/min) with respect to drug solution tank pressure (kPa) has measured with compressed gas (air) flow amount (NL/min) being set to be 0, 5, 10, 15 and 17.5, it has been found that almost linear change characteristic with respect to the drug solution tank pressure is provided, while scarcely affected by the compressed gas flow amount, as are illustrated in FIG. 17 and table 1. The measurement result corresponds to a case where the first pipe 32a has the length of 1000 mm and the inner diameter of 0.3 mm.

TABLE 1

| | Mixed air flow amount: Qa(NL/min) | | | | |
|---|---|---|---|---|---|
| Mist pressurizing force Pw(kPa) | 0 | 5 | 10 | 15 | 17.5 |
| 350 | 4.20 | 4.00 | 4.00 | 4.00 | 4.10 |
| 300 | 3.50 | 3.50 | 3.50 | 3.55 | 3.65 |
| 250 | 2.95 | 2.95 | 2.95 | 2.95 | 3.10 |
| 200 | 2.40 | 2.40 | 2.40 | 2.45 | 2.60 |
| 150 | 1.70 | 1.70 | 1.70 | 1.80 | 1.95 |
| 100 | 0.95 | 0.95 | 1.00 | 1.10 | 1.20 |
| 50 | 0.35 | 0.40 | 0.40 | 0.45 | 0.55 |

Therefore, mist flow amount can easily be controlled to suit intension by drug solution tank pressure with no affection of compressed gas flow amount.

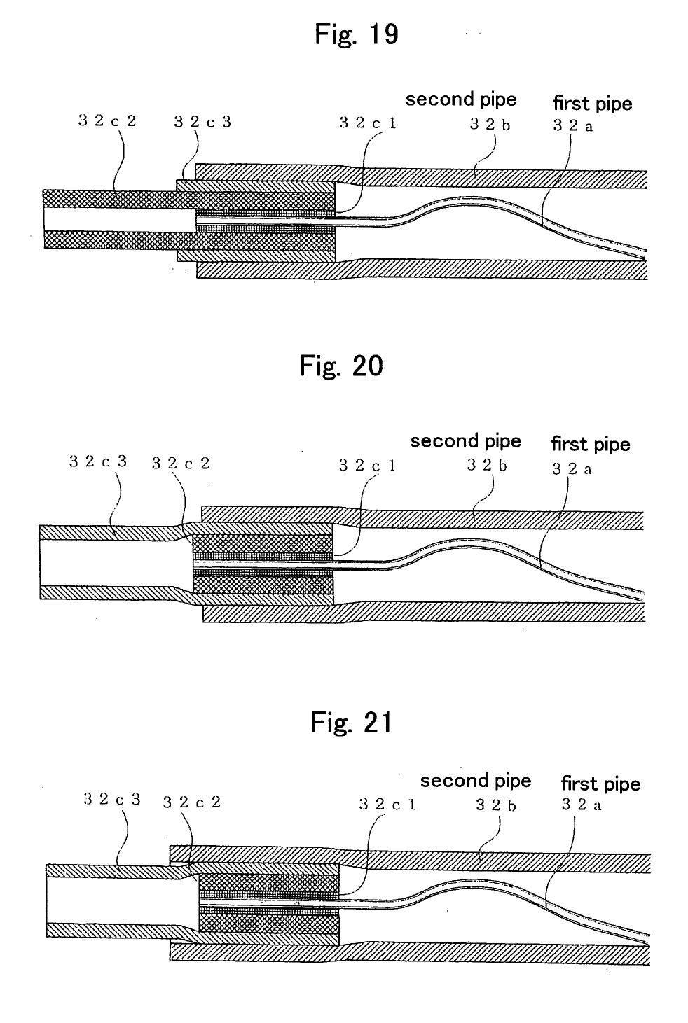

Though the liquid transfer pipe having the above configuration uses the second pipe 32b as a connection section connecting with the drug solution supplying nozzle 2 and the like, the pipe 32c2 may be used as a connection section connecting with the drug solution supplying nozzle 2 and the like, as are illustrated in FIGS. 18 and 19, and the pipe 32c3 may be used as a connection section connecting with the drug solution supplying nozzle 2 and the like.

What is claimed is:

1. A liquid transfer pipe comprising a first pipe for flowing liquid having thin-wall and small diameter, and a second pipe for housing the first pipe having thick-wall and large diameter, wherein the outer diameter of the first pipe and the inner diameter of the second pipe are determined so that the first pipe can be housed with predetermined gap within the second pipe.

2. A liquid transfer system comprising the liquid transfer pipe of claim 1, a liquid housing section communicated to one end of the liquid transfer pipe, a pressurization section for pressurizing the liquid housing section so that liquid is supplied to the liquid transfer pipe from the liquid housing section, a gas blowing section for blowing gas so that negative pressure is generated at the other end of the liquid transfer pipe, and a pressurized gas supplying section for supplying pressurized gas to the gas blowing section.
